(19) United States
(12) Patent Application Publication
(10) Pub. No.: US 2026/0015897 A1
(43) Pub. Date: Jan. 15, 2026

(54) Handle Assembly and Vehicle

(71) Applicant: Illinois Tool Works Inc., Glenview, IL (US)

(72) Inventor: Penghui Yi, Shanghai (CN)

(21) Appl. No.: 19/259,897

(22) Filed: Jul. 3, 2025

(30) Foreign Application Priority Data
Jun. 30, 2025 (CN) 202510889688.1
Jul. 5, 2024 (CN) 202410898223.8

(51) Int. Cl. E05B 85/10; E05B 85/16

(52) U.S. Cl. CPC E05B 85/107; E05B 85/16

(57) ABSTRACT

A handle assembly, used for a vehicle, having: a handle seat; a handle mounted on the handle seat and having a retracted position and an extended position; a rotation mechanism rotatably mounted on the handle seat and operatively coupled to the handle; and at least one inertial piece which is disposed on the rotation mechanism, or at least partially forms the rotation mechanism, or is capable of acting on the rotation mechanism; wherein the at least one inertial piece is configured to move relative to the handle seat when an acceleration of the vehicle exceeds a threshold, and drive the rotation mechanism to rotate in a first rotation direction to drive the handle to move from the retracted position to the extended position. The handle assembly of the present disclosure enables automatic extension of the handle by transferring the inertial energy generated by the collision of the inertial piece to the handle.

### RELATED APPLICATIONS

The present application claims the benefit of Chinese Patent Application Nos. 202410898223.8, filed July 5, 2024, and 202510889688.1, filed June 30, 2025, each titled "Handle Assembly and Vehicle," the contents of which are hereby incorporated by reference.

### TECHNICAL FIELD

The present disclosure relates to a handle assembly and a vehicle having the handle assembly.

### BACKGROUND

In the prior art, a handle of a handle assembly for a vehicle has a retracted position and an extended position. When the handle is in a retracted state, an outer surface of the handle is flush with an outer sheet metal of the vehicle, and an operator is unable to pull the handle to unlock and open a vehicle door. To open the vehicle door, a motor drives the handle to move the handle from the retracted position to the extended position. When the handle is in the extended position, the handle extends out relative to the outer sheet metal of the vehicle, enabling the operator to pull the handle to unlock and open the vehicle door.

### SUMMARY

The present disclosure relates generally to a handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a first embodiment of a handle assembly of the present disclosure in a retracted position.

FIG. 1B is a partially enlarged view of the handle assembly shown in FIG. 1A.

FIG. 1C is a top view of a local part of the handle assembly shown in FIG. 1B.

FIG. 2 is an exploded view of the handle assembly shown in with a handle seat hidden.

FIG. 3 is a perspective view of a first rotation mechanism shown in FIG. 2.

FIG. 4 is a perspective view of a second rotation mechanism shown in FIG. 2.

FIG. 5 is an illustrative view of the partially enlarged view of with a rotation mechanism hidden.

FIG. 6A is a perspective view of the handle assembly shown in FIG. 1A when a handle is driven by the second rotation mechanism to extend out.

FIG. 6B is a partially enlarged view of the handle assembly shown in FIG. 6A.

FIG. 6C is a top view of a local part of the handle assembly shown in FIG. 6B.

FIG. 7A is a perspective view of the handle assembly shown in FIG. 1A when the handle is driven by the first rotation mechanism to extend out.

FIG. 7B is a partially enlarged view of the handle assembly shown in FIG. 7A.

FIG. 7C is a top view of a local part of the handle assembly shown in FIG. 7B.

FIG. 8A is an illustrative view of a second embodiment of a handle assembly of the present disclosure.

FIG. 8B is a partially enlarged view of the handle assembly shown in FIG. 8A.

FIG. 9A is an illustrative view of a third embodiment of a handle assembly of the present disclosure.

FIG. 9B is a partially enlarged view of the handle assembly shown in FIG. 9A.

FIG. 10A is an illustrative view of a fourth embodiment of a handle assembly of the present disclosure.

FIG. 10B is an illustrative view of the handle assembly shown in FIG. 10A with an upper cover hidden.

FIG. 10C is a partially enlarged view of the handle assembly shown in FIG. 10B.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as "first," "second," "top," "bottom," "side," "front," "back," and the like are words of convenience and are not to be construed as limiting terms. For example, while in some examples a first side is located adjacent or near a second side, the terms "first side" and "second side" do not imply any specific order in which the sides are ordered.

The terms "about," "approximately," "substantially," or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language ("e.g.," "such as," or the like) provided herein, is intended merely to better illuminate the disclosed examples and does not pose a limitation on the scope of the disclosure. The terms "e.g.," and "for example" set off lists of one or more non-limiting examples, instances, or illustrations. No language in the specification should be construed as indicating any unclaimed element as essential to the practice of the disclosed examples.

The term "and/or" means any one or more of the items in the list joined by "and/or." As an example, "x and/or y" means any element of the three-element set {(x), (y), (x, y)}. In other words, "x and/or y" means "one or both of x and y". As another example, "x, y, and/or z" means any element of the seven-element set {(x), (y), (z), (x, y), (x, z), (y, z), (x, y, z)}. In other words, "x, y, and/or z" means "one or more of x, y, and z."

It has been found that a motor may fail to work in the event of a vehicle collision and thus fail to drive the handle from the retracted position to the deployed position, resulting in the door being unable to be opened properly.

To at least partially solve above technical problems, according to first aspect of the present disclosure, a handle assembly, used for a vehicle, comprises: a handle seat; a handle mounted on the handle seat and having a retracted position and an extended position; a rotation mechanism rotatably mounted on the handle seat and operatively coupled to the handle; and at least one inertial piece which is disposed on the rotation mechanism, or at least partially forms the rotation mechanism, or is capable of acting on the rotation mechanism; wherein the at least one inertial piece is configured to move relative to the handle seat when an acceleration of the vehicle exceeds a threshold, and drive the rotation mechanism to rotate in a first rotation direction to drive the handle to move from the retracted position to the extended position.

According to first aspect of the present disclosure, the handle assembly further comprises a stop structure, wherein the stop structure is disposed on the handle seat, and is in fit with the rotation mechanism to prevent the rotation mechanism from rotating in a second rotation direction opposite to the first rotation direction when the rotation mechanism is in an initial rotation position thereof.

According to first aspect of the present disclosure, the handle assembly further comprises an elastic limiting structure disposed on the handle seat; wherein the elastic limiting structure is configured to provide the rotation mechanism with a first blocking force that prevents rotation in the first rotation direction when the rotation mechanism is in the initial rotation position, and provide the rotation mechanism with a second blocking force that prevents rotation in the second rotation direction when the rotation mechanism is in a rotation end position thereof.

According to first aspect of the present disclosure, the elastic limiting structure comprises an elastic cantilever connected to the handle seat, the elastic cantilever is provided with a first blocking ramp and a second blocking ramp, wherein the elastic limiting structure provides the first blocking force through the first blocking ramp and provides the second blocking force through the second blocking ramp.

According to first aspect of the present disclosure, the rotation mechanism further comprises a rotational main body and at least one inertial piece acting portion connected to the rotational main body; wherein the at least one inertial piece is disposed on the at least one inertial piece acting portion, or at least partially forms the at least one inertial piece acting portion, or is capable of acting on the at least one inertial piece acting portion.

According to first aspect of the present disclosure, the rotation mechanism is operatively coupled to the handle through the at least one inertial piece acting portion; or the handle assembly further comprises an actuation portion connected to the rotational main body, and the rotation mechanism is operatively coupled to the handle through the actuation portion.

According to first aspect of the present disclosure, the handle assembly further comprises a handle pivot, the handle being fixedly connected to the handle pivot in a rotation direction and being rotatably connected to the handle seat through the handle pivot; and an actuated portion disposed on the handle pivot or the handle; wherein, the rotation mechanism is capable of acting on the actuated portion to operatively couple the rotation mechanism to the handle, to drive, through the rotation mechanism, the handle to rotate.

According to first aspect of the present disclosure, the handle assembly further comprises a handle transmission piece and a handle pivot, the handle transmission piece being fixedly connected to the handle pivot in a rotation direction and being rotatably connected to the handle seat through the handle pivot, and the handle being connected to the handle transmission piece; and an actuated portion disposed on the handle pivot or the handle transmission piece; wherein, the rotation mechanism is capable of acting on the actuated portion to operatively couple the rotation mechanism to the handle, to drive, through the rotation mechanism, the handle transmission piece to rotate, and consequently drive the handle to move.

According to first aspect of the present disclosure, the at least one inertial piece acting portion comprises four inertial piece acting portions disposed around the rotational main body; and the at least one inertial piece comprises four inertial pieces.

According to first aspect of the present disclosure, each of the inertial piece acting portions is arm-shaped, and extends in a radial direction of the rotational main body, wherein extension directions of two adjacent inertial piece acting portions are perpendicular to each other.

According to first aspect of the present disclosure, the four inertial pieces are disposed on the four inertial piece acting portions, respectively, or at least partially form the four inertial piece acting portions, respectively; wherein the rotation mechanism comprises a first rotation mechanism and a second rotation mechanism, and the first rotation mechanism and the second rotation mechanism are rotatable independently of each other; wherein two of the four inertial piece acting portions are disposed on the first rotation mechanism, and the other two of the four inertial piece acting portions are disposed on the second rotation mechanism; and wherein the first rotation mechanism and the second rotation mechanism are arranged in a coaxial manner or in a distributed manner.

According to first aspect of the present disclosure, the handle assembly further comprises at least one sliding groove disposed on the handle seat; wherein the at least one inertial piece is movably accommodated in the at least one sliding groove, and is capable of acting on the at least one inertial piece acting portion during movement thereof, to enable the rotation mechanism to rotate in the first rotation direction.

According to first aspect of the present disclosure, the at least one inertial piece is at least one inertial ball. According to first aspect of the present disclosure, the handle assembly further comprises a return device, wherein the return device is disposed between the handle seat and the rotation mechanism, and provides the rotation mechanism with a return force that causes rotating in a second rotation direction opposite to the first rotation direction.

According to second aspect of the present disclosure, a vehicle comprises: a handle assembly according to first aspect of the present disclosure.

Due to an inertial piece serving as a driving component and a rotation mechanism disposed in the handle assembly of the present disclosure, when the vehicle collides, the inertial piece drives the rotation mechanism to rotate, to drive the handle to extend out, allowing the operator to open the door through the extended handle. Therefore, the handle assembly of the present disclosure enables automatic extension of the handle by transferring the inertial energy generated by the collision of the inertial piece to the handle.

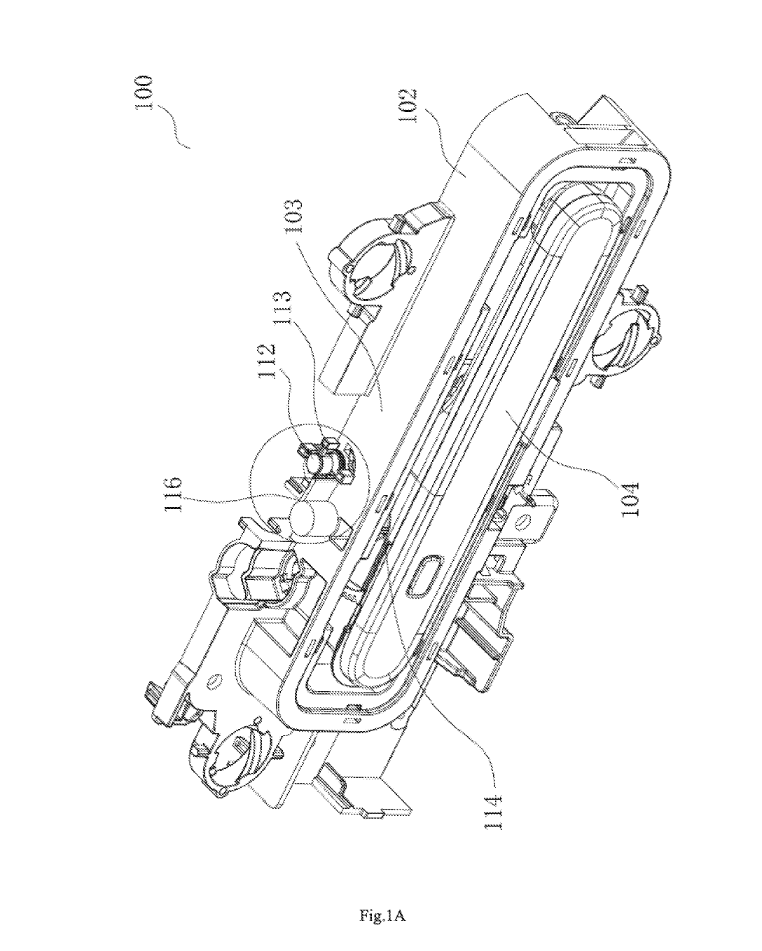

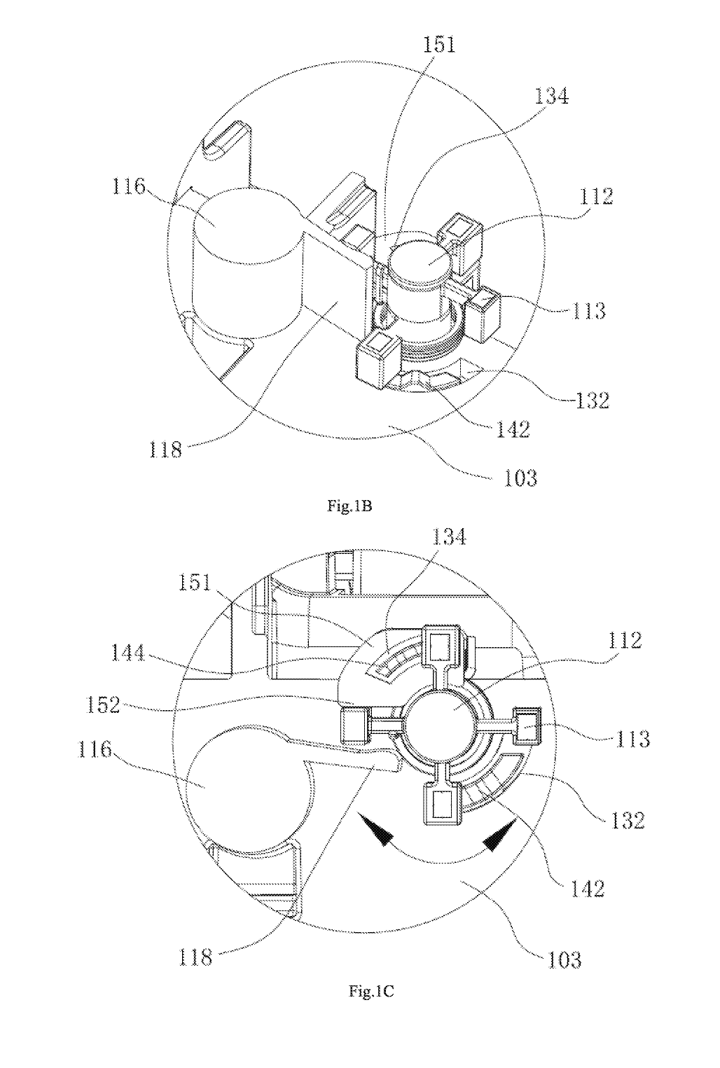

FIG. 1A to FIG. 1C show a first embodiment of a handle assembly of the present disclosure. FIG. 1A is a perspective view of the first embodiment of the handle assembly of the present disclosure in a retracted position. FIG. 1B is a partially enlarged view of the handle assembly shown in FIG. 1A. FIG. 1C is a top view of a partially enlarged view of the handle assembly shown in FIG. 1B.

As shown in FIG. 1A, the handle assembly 100 includes a handle seat 102, a handle 104, a rotation mechanism 112, and at least one inertial piece 113 disposed on the rotation mechanism 112. The handle assembly 100 is mounted to a door of a vehicle (not shown) through the handle seat 102. The handle 104 is mounted on the handle seat 102 and has a retracted position and an extended position relative to the handle seat 102. The rotation mechanism 112 is rotatably mounted to an upper seat surface 103 of the handle seat 102, and is operatively coupled to the handle 104. The inertial piece 113 serves as an inertial driving component, and is configured to move relative to the handle seat 102 when the vehicle is subjected to a collision resulting in a relatively large instantaneous acceleration. The movement of the inertial piece 113 can drive the rotation mechanism 112 to rotate, and drive, through the rotation mechanism 112, the handle 104 of the vehicle to rotate.

Still referring to FIG. 1A, the handle assembly 100 further includes a handle pivot 114 and an actuated portion 116. The handle 104 is fixedly connected to the handle pivot 114 in a rotation direction so that the handle and the handle pivot can rotate together. The handle 104 is rotatably connected to the handle seat 102 through the handle pivot 114. The handle pivot 114 extends out from the upper seat surface 103 of the handle seat 102. The actuated portion 116 is disposed at an end of the handle pivot 114. Those skilled in the art should understand that in other embodiments, the actuated portion 116 may be, instead, disposed on the handle 104 that rotates together with the handle pivot 114. The rotation mechanism 112 is capable of acting on the actuated portion 116 to operatively couple the rotation mechanism 112 to the handle 104, to drive, through the rotation mechanism 112, the handle 104 to rotate.

In the embodiment shown in FIG. 1A, the handle 104 moves from the retracted position to the extended position by rotating. Those skilled in the art should understand that in other embodiments, the handle 104 may move from the retracted position to the extended position by translational motion instead. Specifically, the handle assembly 100 further includes a handle transmission piece (not shown in the figure) such as a linkage. The handle transmission piece is fixedly connected to the handle pivot 114 in a rotation direction, and is rotatably connected to the handle seat 102 through the handle pivot. The handle 104 is connected to the handle transmission piece. The actuated portion 116 is disposed at an end of the handle pivot 114. The rotation mechanism 112 is capable of acting on the actuated portion 116 to operatively couple the rotation mechanism 112 to the handle 104, to drive, through the rotation mechanism 112, the handle transmission piece to rotate, and consequently drive the handle 104 to rotate. In other embodiments, the actuated portion 116 may be, instead, disposed on the handle transmission piece that rotates together with the handle pivot 114.

As shown in FIG. 1B to FIG. 1C, the actuated portion 116 includes a baffle 118 extending in a tangential or radial direction of the handle pivot and configured to be in mutual abutment with the rotation mechanism 112. The baffle 118 is capable of being actuated by the rotation mechanism 112 to rotate during rotation of the rotation mechanism 112, thereby driving the handle 104 to rotate.

Still referring to FIG. 1B to FIG. 1C, the handle assembly further includes two elastic limiting structures 142, 144 disposed on the handle seat 102 and clearance grooves 132, 134 configured to at least partially accommodate the elastic limiting structures 142, 144 during movement of the elastic limiting structures 142, 144. The elastic limiting structures 142, 144 are configured to limit the movement of the rotation mechanism 112.

The upper seat surface 103 includes a stepped structure 151 formed by protruding upward from the upper seat surface 103 of the handle seat 102. The clearance grooves 132, 134 are arcuate. One of the clearance grooves 132 is disposed on the upper seat surface 103. Another clearance groove 134 is disposed on the upper surface of the stepped structure 151. Each of the two elastic limiting structures 142, 144 extends along the upper seat surface 103 or the upper surface of the stepped structure 151 in a corresponding one of the two arcuate clearance grooves 132, 134. When subjected to a compressive force, the elastic limiting structures 142, 144 can flexibly deflect in a direction perpendicular to the upper seat surface 103, thereby retracting into the clearance grooves 132, 134. The elastic limiting structures 142, 144 can provide, when the rotation mechanism 112 is in an initial rotation position, the rotation mechanism 112 with a first blocking force that prevents the rotation mechanism from rotating in a first rotation direction (counterclockwise), and provide, when the rotation mechanism 112 is in a rotation end position, the rotation mechanism 112 with a second blocking force that prevents the rotation mechanism from rotating in a second rotation direction (clockwise).

Still referring to FIG. 1B and FIG. 1C, the handle assembly further includes a stop structure 152 disposed on the handle seat 102. The stop structure is configured to be in fit with the rotation mechanism 112 to, when the rotation mechanism 112 is in the initial rotation position thereof, prevent the rotation mechanism 112 from rotating in the second rotation direction opposite to the first rotation direction. In the illustrated embodiment, the stop structure 152 is a sidewall disposed on the upper seat surface 103.

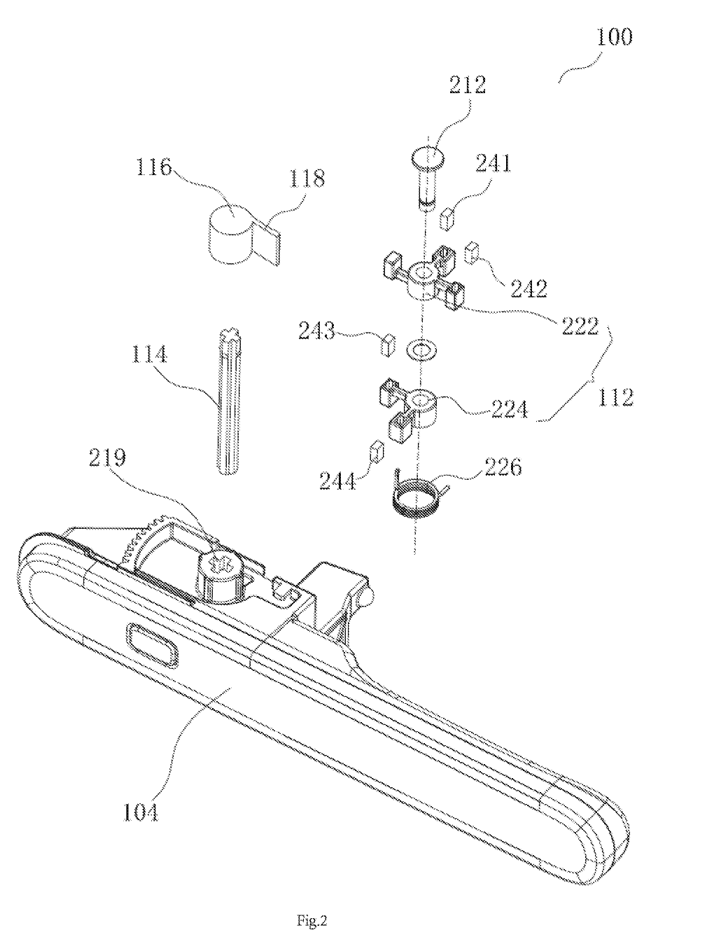

FIG. 2 is an exploded view of the handle assembly shown in FIG. 1A with the handle seat hidden to more clearly exhibit a mating relationship between components.

As shown in FIG. 2, the handle 104 is provided with a pivot connecting portion 219 fixedly connected to the handle pivot 114, to enable the handle 104 to be driven by the rotation of the handle pivot 114. One end of the handle pivot 114 is connected to the pivot connecting portion 219, and the other end thereof is connected to the actuated portion 116 through the upper seat surface of the handle seat, thereby fixing the handle 104 and the actuated portion 116 together, and enabling the handle 104 to rotate along with the rotation of the actuated portion 116.

Still referring to FIG. 2, the rotation mechanism 112 includes a first rotation mechanism 222 and a second rotation mechanism 224 that rotate independently of each other. At least one inertial piece is four counterweights 241, 242, 243, 244. The four counterweights 241, 242, 243, 244 are of relatively high density and mass, and are made of iron weight or lead weight. Of the four counterweights, two counterweights 241, 242 are disposed on the first rotation mechanism 222, and the other two counterweights 243, 244 are disposed on the second rotation mechanism 224, thereby increasing rotational inertia of the first rotation mechanism 222 and the second rotation mechanism 224. The pivot 212 of the rotation mechanism 112 passes through the first rotation mechanism 222 and the second rotation mechanism 224 sequentially, and is mounted on the handle seat, so that the first rotation mechanism 222 and the second rotation mechanism 224 each can rotate independently around the pivot 212 on the upper seat surface.

Still referring to FIG. 2, the handle assembly further includes a return device 226. In an embodiment of the present disclosure, the return device 226 is a torsion spring. The return device 226 is disposed between the handle seat and the first rotation mechanism 222 , the second rotation mechanism 224, and is configured to provide the first rotation mechanism 222 and the second rotation mechanism 224 with a return force that causes rotating in the second rotation direction.

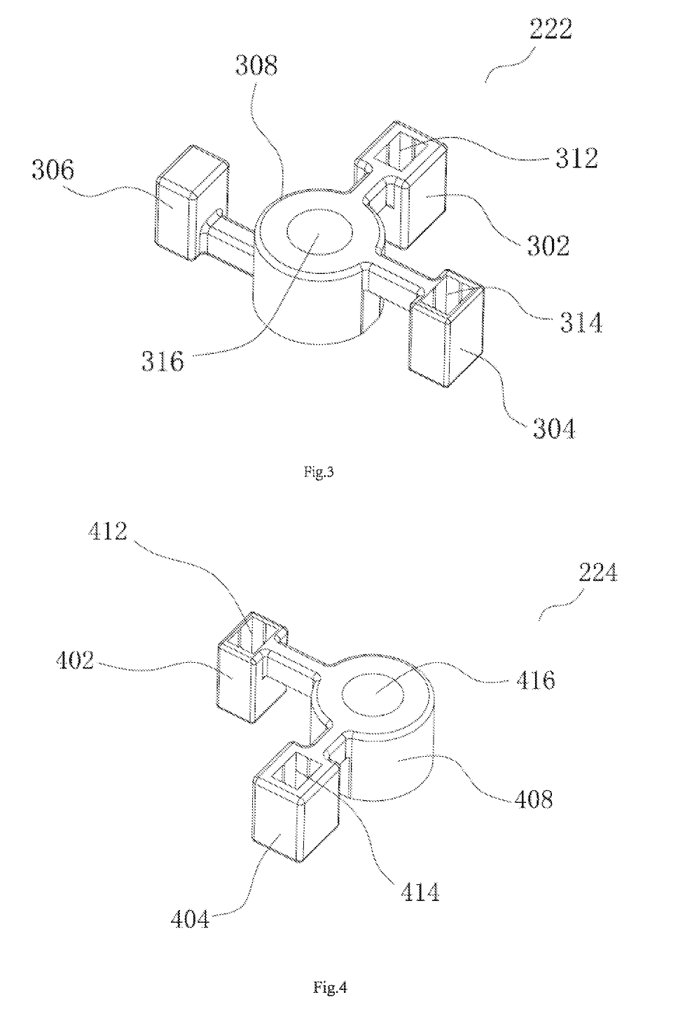

FIG. 3 and FIG. 4 show specific structures of the first rotation mechanism and the second rotation mechanism. FIG. 3 is a perspective view of the first rotation mechanism shown in FIG. 2. FIG. 4 is a perspective view of the second rotation mechanism shown in FIG. 2.

As shown in FIG. 3, the first rotation mechanism 222 includes a first rotation body 308, at least one inertial piece acting portion, and an actuation portion 306. The at least one inertial piece acting portion and the actuation portion 306 are connected to the first rotation body 308. The first rotation mechanism 222 is operatively coupled to the handle by the actuation portion 306. At least one inertial piece is disposed on at least one inertial piece acting portion. The first rotation body 308 is a hollow cylindrical structure, and includes a first pivot cavity 316 running through the first rotation body 308 from top to bottom. The first pivot cavity is used to mount the pivot. In the illustrated embodiment, in the first rotation mechanism 222, at least one inertial piece acting portion includes two first inertial piece acting portions 302, 304. The two first inertial piece acting portions 302, 304 are arm-shaped, and extends radially outward from the first rotation body 308. A first receiving groove 312, 314 is disposed at a distal end of each of the two first inertial piece acting portions 302, 304, and is configured to accommodate a counterweight. In the illustrated embodiment, two first inertial piece acting portions 302, 304 are perpendicular to each other. The actuation portion 306 is disposed radially opposite one of the first inertial piece acting portions 304. In other embodiments, the two first inertial piece acting portions 302, 304 and the actuation portion 306 may be disposed at another angle to each other instead. In the illustrated embodiment, the shape of the actuation portion 306 is similar to the shapes of the first inertial piece acting portions 302, 304.

The first inertial piece acting portions 302, 304 and the actuation portion 306 are all connected to the first rotation body 308. Therefore, the actuation portion 306 rotates in synchronism with the two first inertial piece acting portions 302, 304. The actuation portion 306 and the actuated portion are operatively coupled, for example, in abutment with each other. Rotation of the actuation portion 306 in the counterclockwise direction causes the actuated portion to rotate, thereby driving the handle to rotate.

As shown in FIG. 4, the second rotation mechanism 224 includes a second rotation body 408 and at least one inertial piece acting portion. The at least one inertial piece acting portion is connected to the second rotation body 408. The second rotation mechanism 224 is operatively coupled to the handle through at least one inertial piece acting portion. At least one inertial piece is disposed on at least one inertial piece acting portion. The second rotation body 408 is a hollow cylindrical structure, and includes a second pivot cavity 416 running through the second rotation body 408 from top to bottom. The second pivot cavity is used to mount the pivot. In an embodiment of the present disclosure, in the second rotation mechanism 224, at least one inertial piece acting portion includes two second inertial piece acting portions 402, 404. The two second inertial piece acting portions 402, 404 are arm-shaped, and extends radially outward from the second rotation body 408. A second receiving groove 412, 414 is disposed at a distal end of each of the two second inertial piece acting portions 402, 404, and is configured to accommodate a counterweight. In an embodiment of the present disclosure, the two second inertial piece acting portions 402, 404 are perpendicular to each other. In other embodiments, the second inertial piece acting portions 402, 404 may extend at another angle to each other instead.

The two second inertial piece acting portions 402, 404 are both connected to the second rotation body 408. Therefore, the two second inertial piece acting portions 402, 404 rotate synchronously. One second inertial piece acting portion 402 of the two second inertial piece acting portions 402, 404 is operatively coupled to, for example, in mutual abutment with, the actuated portion. Rotation of the second inertial piece acting portion 402 in the counterclockwise direction causes the actuated portion to rotate, thereby driving the handle to rotate.

In the embodiments shown in FIG. 2 to FIG. 4, the handle assembly includes four inertial piece acting portions. The four inertial piece acting portions are disposed around the rotational main body, and include four inertial pieces. Specifically, the first rotation mechanism 222 and the second rotation mechanism 224 of the rotation mechanisms 112 collectively include four inertial piece acting portions 302, 304, 402, 404, each being disposed around a corresponding rotational main body. Each of the four inertial piece acting portions is a corresponding inertial piece acting portion among the four inertial piece acting portions 302, 304, 402, 404. Each inertial piece acting portion extends outward in a radial direction of the rotational main body. The extension directions of two adjacent inertial piece acting portions are perpendicular to each other. The four inertial pieces are four counterweights 241, 242, 243, 244, each being disposed in a corresponding receiving groove of the four inertial piece acting portions. Two inertial piece acting portions (for example, two first inertial piece acting portions 302, 304) of the four inertial piece acting portions are disposed on the first rotation mechanism 222, and two other inertial piece acting portions (for example, two second inertial piece acting portions 402, 404) of the four inertial piece acting portions are disposed on the second rotation mechanism 224.

Referring to FIG. 2 to FIG. 4, in a direction perpendicular to the upper seat surface 103, the first rotation mechanism 222 is mounted above the second rotation mechanism 224, and the first rotation mechanism 222 is arranged coaxially with the second rotation mechanism 224. The actuation portion 306 of the first rotation mechanism 222 coincides with one second inertial piece acting portion 402 of the second rotation mechanism 224 in a vertical direction.

The two first inertial piece acting portions 302, 304 of the first rotation mechanism 222 cruciformly intersect the two second inertial piece acting portions 402, 404 of the second rotation mechanism 224. This causes the two first inertial piece acting portions 302, 304 of the first rotation mechanism 222 and the two second inertial piece acting portions 402, 404 of the second rotation mechanism 224 to extend in four different directions, respectively. In this way, when the vehicle is subjected to a collision force from any direction, a corresponding inertial piece acting portion can be driven by an inertial piece to rotate, thereby enabling at least one of the first rotation mechanism 222 or the second rotation mechanism 224 to rotate in the first rotation direction.

Those skilled in the art should understand that in other embodiments, the four inertial piece acting portions of the first rotation mechanism 222 and the second rotation mechanism 224 may be arranged such that two adjacent ones are at another angle to each other instead of the configuration in which two adjacent ones are perpendicular to each other.

Those skilled in the art should understand that in other embodiments, the first rotation mechanism 222 and the second rotation mechanism 224 may be arranged in such a manner as to rotate in the second rotation direction (clockwise) to drive the handle to rotate.

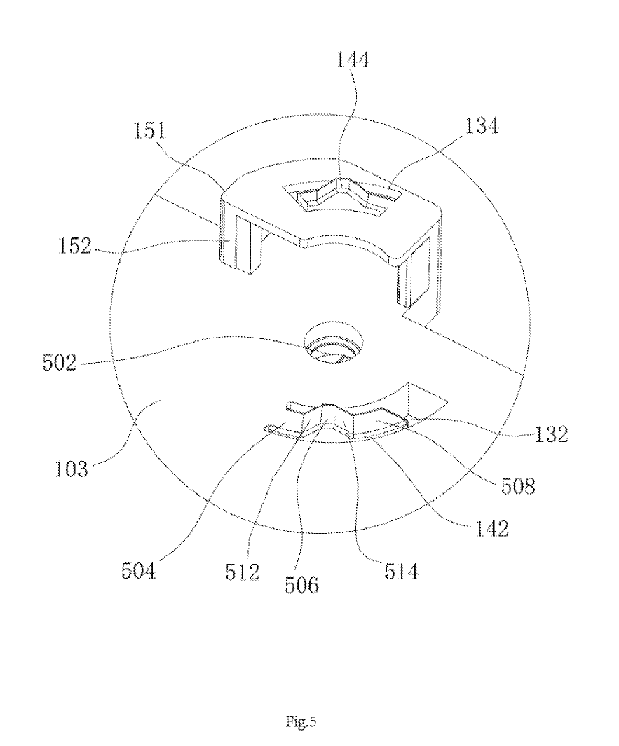

FIG. 5 is an illustrative view of the partially enlarged view of FIG. 1B with a rotation mechanism hidden to more clearly exhibit the elastic limiting structures 142, 144 on the upper seat surface 103.

As shown in FIG. 5, the upper seat surface 103 of the handle seat 102 is provided with a pivot opening 502 for mounting a pivot. The circular arc shapes of the two arcuate clearance grooves 132, 134 coincide with the circular arc shapes of rotation paths of the inertial piece acting portions of the first rotation mechanism 222 and the second rotation mechanism 224 respectively. The stepped structure 151 includes a stop structure 152. When the rotation mechanism is in an initial rotation position thereof, the stop structure 152 can block the actuation portion 306 of the first rotation mechanism 222 and the inertial piece acting portion 402 of the second rotation mechanism 224 (referring to FIG. 3 to FIG. 4), thereby preventing the first rotation mechanism 222 and the second rotation mechanism 224 from rotating in the second rotation direction. The structures of the two elastic limiting structures 142, 144 are the same, and the elastic limiting structure 142 is described as an example, but without describing the elastic limiting structure 144 repeatedly. The elastic limiting structure 142 includes an elastic cantilever connected to a handle seat 102. The elastic cantilever extends in the clearance groove 132 in a circular arc direction of the clearance groove 132. Specifically, the elastic cantilever includes a first extension section 504, an extension protruding section 506, and a second extension section 508. The first extension section 504 is formed by extending a distance in a horizontal direction from the handle seat 102. The extension protruding section 506 extends a distance from the first extension section 504 in an obliquely upward direction and then extends to the original height in an obliquely downward direction, thereby forming a first blocking ramp 512 and a second blocking ramp 514, separately. The second extension section 508 is formed by extending a further distance in the horizontal direction from the extension protruding section 506. The elastic limiting structure 142 provides a first blocking force through the first blocking ramp 512 and provides a second blocking force through the second blocking ramp 514.

Referring to FIG. 1A to FIG. 5, using the rotation of the second rotation mechanism 224 as an example, the second rotation mechanism 224 includes an initial rotation position and a rotation end position during counterclockwise rotation, which correspond to a retracted position and an extended position of the handle 104, respectively. When the second rotation mechanism 224 is in the initial rotation position (the handle 104 is in the retracted position), one of the second inertial piece acting portions 404 of the second rotation mechanism is in the first extension section 504 of the elastic limiting structure 142. The first blocking ramp 512 may abut the second inertial piece acting portion in the first rotation direction of the second inertial piece acting portion 404, and the stop structure 152 may block the second inertial piece acting portion in the second rotation direction of the second inertial piece acting portion 402 to limit the rotation of the second rotation mechanism 224. The first blocking ramp 512 may provide a first blocking force that does not exceed a threshold. When the second rotation mechanism 224 is in the rotation end position (the handle 104 is in the extended position), the second inertial piece acting portion 404 is in the second extension section 508 of the elastic limiting structure 142, and the second blocking ramp 514 can abut the second inertial piece acting portion in the second rotation direction of the second inertial piece acting portion 404 to restrict the second rotation mechanism 224 from rotating in the second rotation direction. The purpose of this arrangement is to keep the handle in an extended state without retracting.

The vehicle generates a large instantaneous acceleration when subjected to an external collision, where the instantaneous acceleration is usually greater than 30g (wherein g represents an acceleration due to gravity). The inertial piece is capable of moving relative to the handle seat 102 when the acceleration of the vehicle at any horizontal direction exceeds a threshold (for example, exceeds the above acceleration value), to drive the rotation mechanism to rotate in the first rotation direction, and consequently drive the handle 104 to move from the retracted position to the extended position.

In a case of a collision of the vehicle, when a difference between an inertial force of the counterweight 244 acting on the second inertial piece acting portion 404 and a return force provided by the return device 226 exceeds a specified threshold, the second inertial piece acting portion 404 presses the first blocking ramp 512 such that the elastic limiting structure 142 deflects elastically in a direction perpendicular to the upper seat surface 103. The second inertial piece acting portion 404 overcomes a first blocking force of the first blocking ramp 512, thereby causing the second rotation mechanism 224 to rotate in the first rotation direction, and consequently driving the handle 104 to move from the retracted position to the extended position. When the difference between the inertial force of the counterweight 244 acting on the second inertial piece acting portion 404 and the return force provided by the return device 226 does not exceed the threshold, the pressing force of the second inertial piece acting portion 404 fails to deflect the elastic limiting structure 142 elastically, thereby failing to overcome the first blocking force of the first blocking ramp 512. The second rotation mechanism 224 does not rotate, and therefore, the handle 104 is unable to move from the retracted position to the extended position. This arrangement prevents the handle 104 from being undesirably extended out as driven by the inertial piece due to small wobbling or shaking of the vehicle during normal running of the vehicle.

If the handle 104 needs to be reset after being extended out, because the return device 226 provides a return force that causes rotating in the second rotation direction, only a force smaller than the threshold is required to cause the second rotation mechanism 224 to rotate toward the initial rotation position against the second blocking force of the second blocking ramp 514.

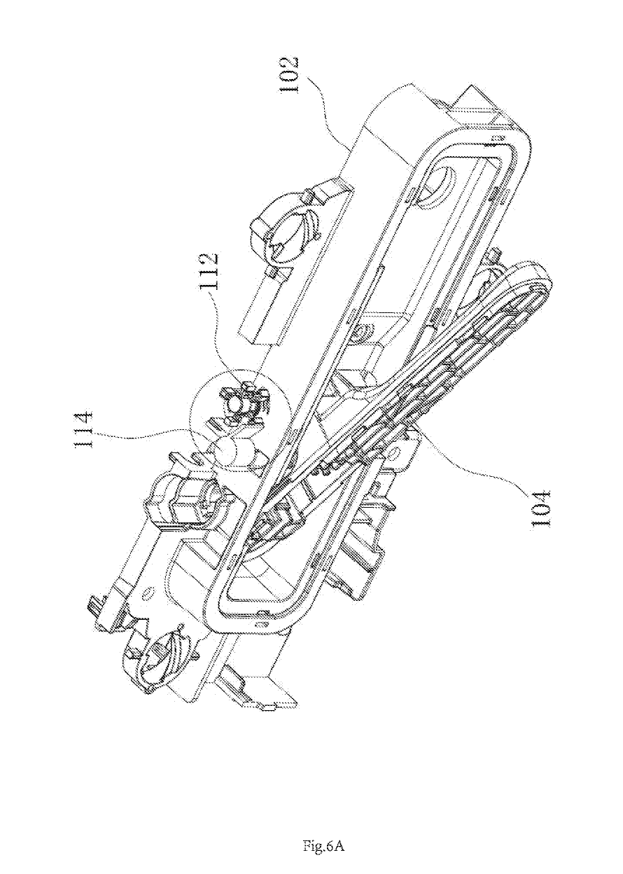

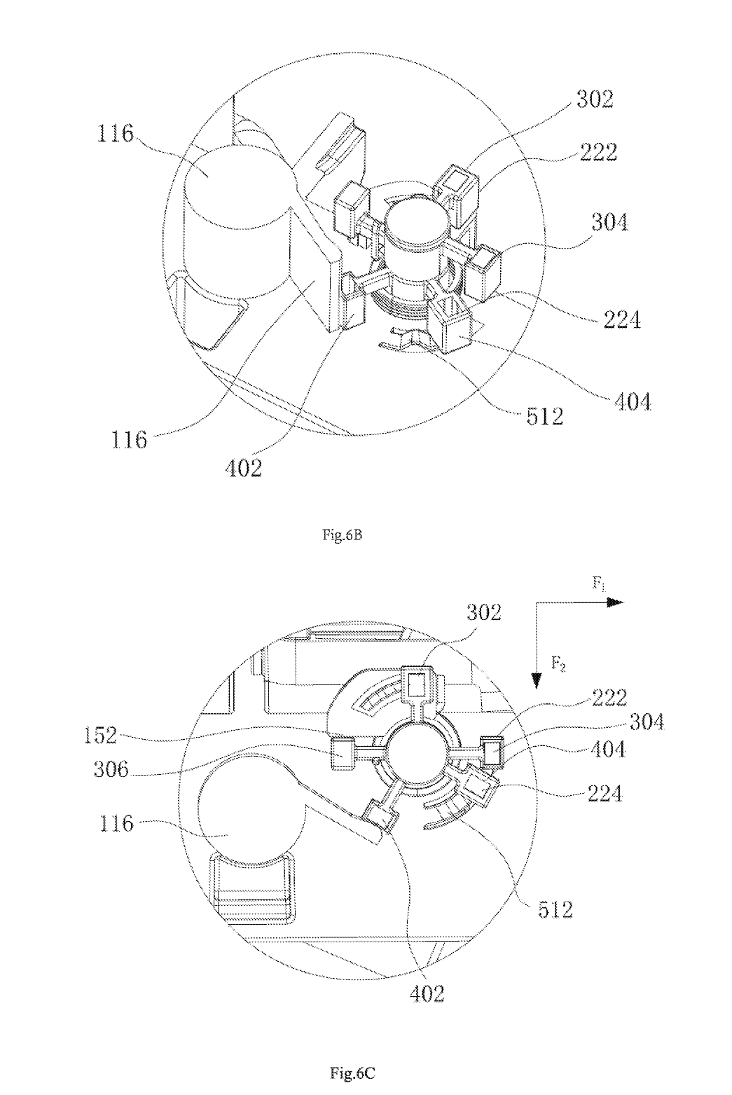

FIG. 6A to FIG. 6C shows a mating relationship between components of the handle assembly when the handle is extended out as driven by the second rotation mechanism. FIG. 6A is a perspective view of the handle assembly, FIG. 6B is a partially enlarged view of the handle assembly, and FIG. 6C is a top view of a partially enlarged view of the handle assembly shown in FIG. 6B.

As shown in FIG. 6A to FIG. 6C, when the vehicle is subjected to a collision force F1 (referring to FIG. 6C) from a front side direction, the inertial piece acting portion 302 of the first rotation mechanism 222 and the inertial piece acting portion 404 of the second rotation mechanism 224, which extend in a direction perpendicular to the front side direction, are driven by the inertial piece to cause the first rotation mechanism 222 to generate a tendency to rotate in the second rotation direction, and to cause the second rotation mechanism 224 to generate a tendency to rotate in the first rotation direction. Because the actuation portion 306 of the first rotation mechanism 222 is in mutual abutment with the stop structure 152, the tendency of the actuation portion 306 to rotate in the second rotation direction is blocked by the stop structure 152, and the first rotation mechanism 222 does not rotate. The tendency of the second rotation mechanism 224 to rotate in the first rotation direction causes the inertial piece acting portion 404 to rotate in the first rotation direction against the first blocking force of the first blocking ramp 512, and ultimately drives the handle to move from the retracted position to the extended position.

Still referring to FIG. 6A to FIG. 6C, when the vehicle is subjected to a collision force F2 (referring to FIG. 6C) from a right side direction, the inertial piece acting portion 304 of the first rotation mechanism 222 and the inertial piece acting portion 402 of the second rotation mechanism 224, which extend in a direction perpendicular to the right side direction, generate rotational inertia to cause the first rotation mechanism 222 to generate a tendency to rotate in the second rotation direction, and to cause the second rotation mechanism 224 to generate a tendency to rotate in the first rotation direction. Because the actuation portion 306 of the first rotation mechanism 222 is in mutual abutment with the stop structure 152, the tendency of the actuation portion 306 to rotate in the second rotation direction is blocked by the stop structure 152, and the first rotation mechanism 222 does not rotate. The tendency of the second rotation mechanism 224 to rotate in the first rotation direction causes the inertial piece acting portion 404 to rotate in the first rotation direction against the first blocking force of the first blocking ramp 512, and ultimately drives the handle to move from the retracted position to the extended position.

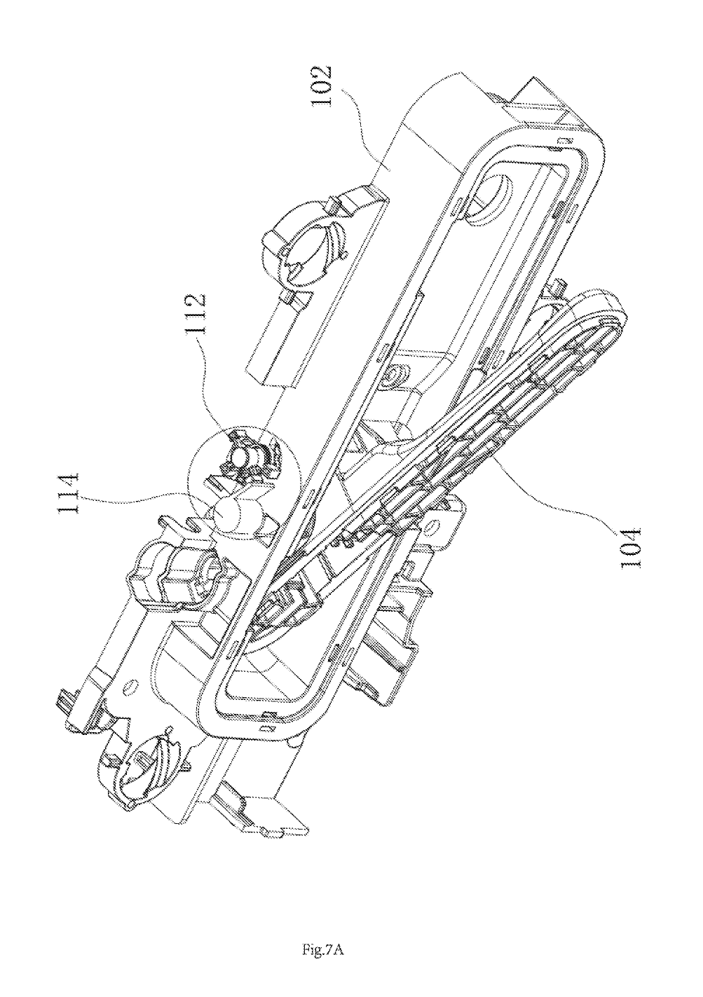

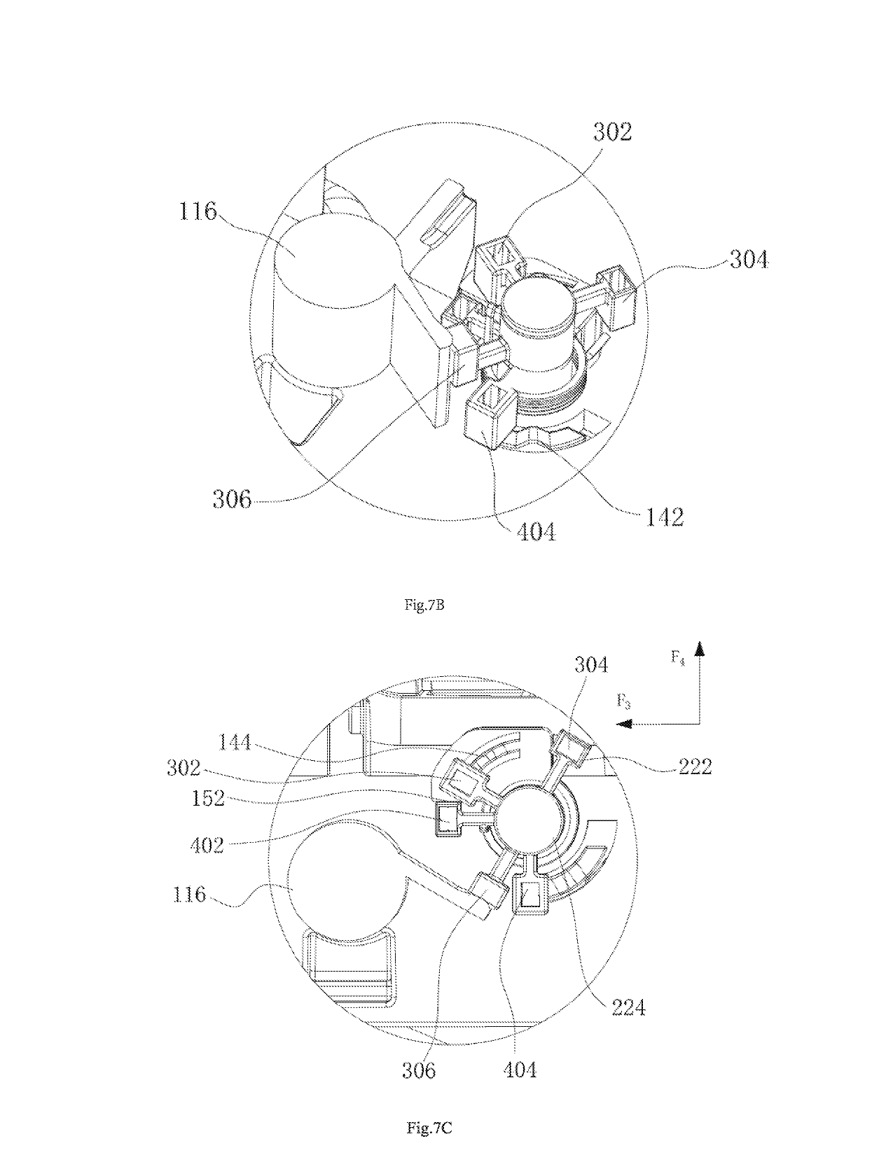

FIG. 7A to FIG. 7C shows a mating relationship between components of the handle assembly when the handle is extended out as driven by the first rotation mechanism. FIG. 7A is a perspective view of the handle assembly, FIG. 7B is a partially enlarged view of the handle assembly, and FIG. 7C is a top view of a partially enlarged view of the handle assembly shown in FIG. 7B.

As shown in FIG. 7A to FIG. 7C, when the vehicle is subjected to a collision force F3 (referring to FIG. 7C) from a rear side direction, the inertial piece acting portion 302 of the first rotation mechanism 222 and the inertial piece acting portion 404 of the second rotation mechanism 224, which extend in a direction perpendicular to the rear side direction, are driven by the inertial piece to cause the first rotation mechanism 222 to generate a tendency to rotate in the first rotation direction, and to cause the second rotation mechanism 224 to generate a tendency to rotate in the second rotation direction. Because the inertial piece acting portion 402 of the second rotation mechanism 224 is in mutual abutment with the stop structure 152, the tendency of the inertial piece acting portion 402 to rotate in the second rotation direction is blocked by the stop structure 152, and the second rotation mechanism 224 does not rotate. The tendency of the first rotation mechanism 222 to rotate in the first rotation direction causes the inertial piece acting portion 302 to rotate in the first rotation direction against the elastic force of the elastic limiting structure 144, and ultimately drives the handle to move from the retracted position to the extended position.

Still referring to FIG. 7A to FIG. 7C, when the vehicle is subjected to a collision force F4 (referring to FIG. 7C) from a left side direction, the inertial piece acting portion 304 of the first rotation mechanism 222 and the inertial piece acting portion 402 of the second rotation mechanism 224, which extend in a direction perpendicular to the left side direction, generate rotational inertia to cause the first rotation mechanism 222 to generate a tendency to rotate in the first rotation direction, and to cause the second rotation mechanism 224 to generate a tendency to rotate in the second rotation direction. Because the inertial piece acting portion 402 of the second rotation mechanism 224 is in mutual abutment with the stop structure 152, the tendency of the inertial piece acting portion 402 to rotate in the first rotation direction is blocked by the stop structure 152, and the second rotation mechanism 224 does not rotate. The tendency of the first rotation mechanism 222 to rotate in the first rotation direction causes the inertial piece acting portion 302 to rotate in the first rotation direction against the elastic force of the elastic limiting structure 144, and ultimately drives the handle to move from the retracted position to the extended position.

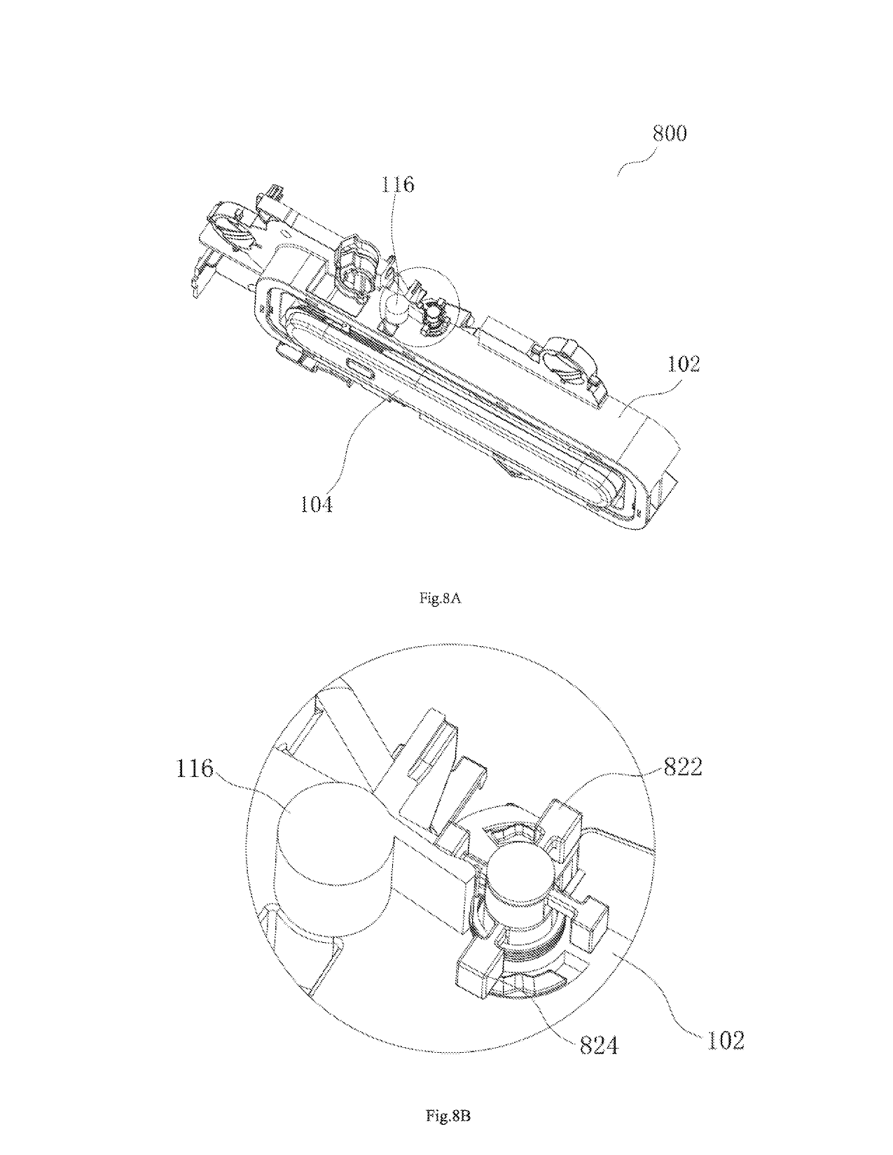

FIG. 8A and FIG. 8B show a second embodiment of a handle assembly of the present disclosure. FIG. 8A is an illustrative view of the second embodiment of the handle assembly of the present disclosure. FIG. 8B is a partially enlarged view of the handle assembly shown in FIG. 8A. The handle assembly 800 shown in FIG. 8A to FIG. 8B differs from the handle assembly 100 in FIG. 1A in the arrangement of the inertial piece, and the same components and structures are not described here again.

Specifically, in the handle assembly 100, the inertial piece is detachably disposed on the rotation mechanism. A receiving groove configured to accommodate a counterweight is disposed at a distal end of the inertial piece acting portion of the rotation mechanism.

In contrast, as shown in FIG. 8A and FIG. 8B, in the handle assembly 800, the inertial piece at least partially forms the inertial piece acting portion of the rotation mechanism. Specifically, each of the four inertial pieces is integrally molded together with a corresponding one of the four inertial piece acting portions, for example, is manufactured from a lead or iron material. This arrangement simplifies the structure of the first rotation mechanism 822 and the second rotation mechanism 824, reduces the number of components, and consequently simplifies assembling. In some embodiments, the first rotation mechanism 822 or the second rotation mechanism 824 are integrally formed from the material of the inertial piece.

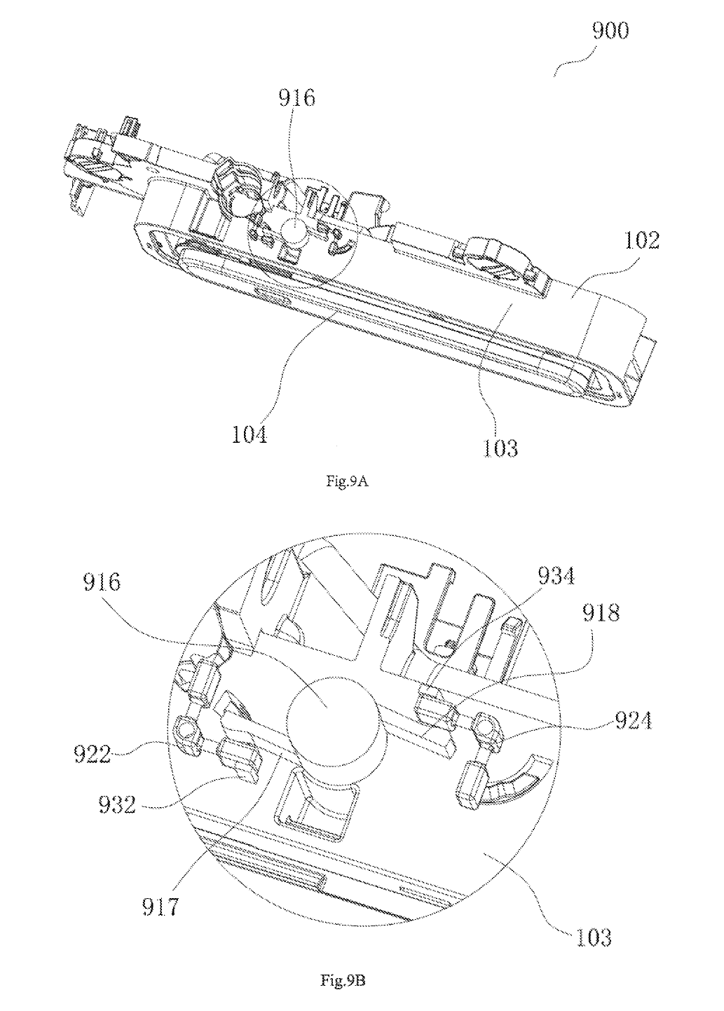

FIG. 9A and FIG. 9B show a third embodiment of a handle assembly of the present disclosure. FIG. 9A is an illustrative view of the third embodiment of the handle assembly of the present disclosure. FIG. 9B is a partially enlarged view of the handle assembly shown in FIG. 9A. The handle assembly 900 shown in FIG. 9A to FIG. 9B differs from the handle assembly 100 in FIG. 1A in the arrangement of the rotation mechanism, and the same components and structures are not described here again.

As shown in FIG. 9A to FIG. 9B, the actuated portion 916 includes two baffles 917, 918. The two baffles 917, 918 extend outward from the pivot center of the actuated portion 916 separately. In the first embodiment of the present disclosure, the first rotation mechanism and the second rotation mechanism are arranged coaxially. In contrast, in the third embodiment of the present disclosure, the first rotation mechanism 922 and the second rotation mechanism 924 are arranged in a distributed manner, for example, disposed on two sides of the actuated portion 916, respectively. In order to prevent the first rotation mechanism 922 and the second rotation mechanism 924 from rotating in the second rotation direction, two stop structures 932, 934 are disposed on the upper seat surface 103. The first rotation mechanism 922 is disposed on one side of the actuated portion 916. One inertial piece acting portion of the first rotation mechanism 922 abuts one baffle 917 of the two baffles 917, 918, and is configured to actuate rotation of the actuated portion 916. The second rotation mechanism 924 is disposed on the other side of the actuated portion 916. One inertial piece acting portion of the second rotation mechanism 924 abuts the other baffle 918 of the two baffles 917, 918, and is configured to actuate rotation of the actuated portion 916.

In a third embodiment of the present disclosure, such a non-coaxial distributed arrangement of the first rotation mechanism 922 and the second rotation mechanism 924 makes the arrangement of the rotation mechanism more flexible, and utilizes the space of the handle seat 102 more efficiently.

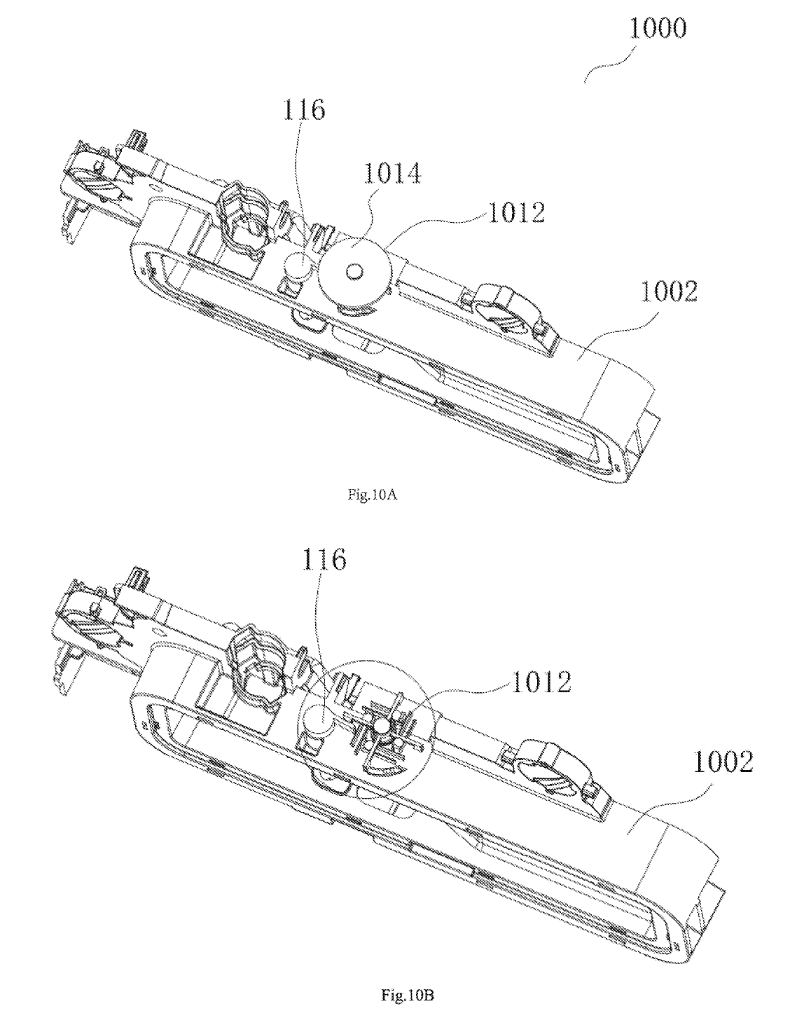

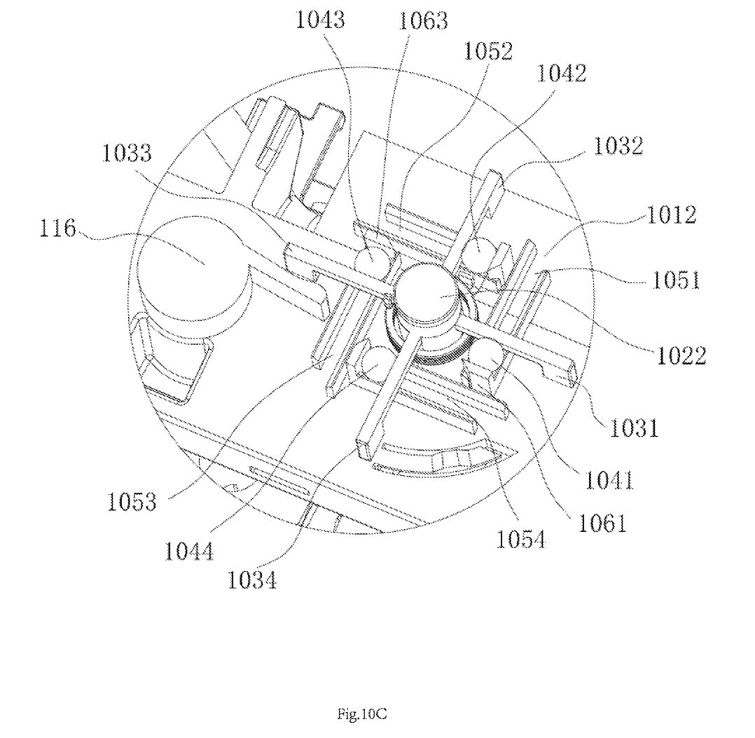

FIG. 10A to FIG. 10C show a fourth embodiment of a handle assembly of the present disclosure. FIG. 10A is an illustrative view of the fourth embodiment of the handle assembly of the present disclosure, FIG. 10B is an illustrative view of the handle assembly shown in FIG. 10A with an upper cover hidden, and FIG. 10C is a partially enlarged view of the handle assembly shown in FIG. 10B. The handle assembly 1000 shown in FIG. 10A to FIG. 10C differs from the handle assembly 100 in FIG. 1A in the arrangement of the inertial piece, and the same components and structures are not described here again.

As shown in FIG. 10A to FIG. 10C, the handle assembly 1000 includes a rotation mechanism 1012, at least one inertial piece, and at least one sliding groove. At least one sliding groove is disposed on the handle seat 1002. The at least one inertial piece is movably accommodated in the at least one sliding groove, and is capable of acting on the at least one inertial piece acting portion of the rotation mechanism during movement thereof, to enable the rotation mechanism to rotate in the first rotation direction. The at least one inertial piece may be at least one inertial ball. Specifically, the rotation mechanism 1012 includes an upper cover 1014, a rotation body 1022, and four inertial piece acting portions 1031, 1032, 1033, 1034. The at least one inertial piece is four inertial balls 1041, 1042, 1043, 1044. The at least one sliding groove is four sliding grooves 1051, 1052, 1053, 1054. The upper cover 1014 overlays the four inertial piece acting portions 1031, 1032, 1033, 1034, the four sliding grooves 1051, 1052, 1053, 1054, and the four inertial balls 1041, 1042, 1043, 1044 to prevent the four inertial balls 1041, 1042, 1043, 1044 from detaching from the four sliding grooves 1051, 1052, 1053, 1054. The four inertial piece acting portions 1031, 1032, 1033, 1034 extend outward in different directions from the rotation body 1022. For example, every two thereof extend perpendicular to each other to assume a cruciform structure. One inertial piece acting portion 1033 of the four inertial piece acting portions 1031, 1032, 1033, 1034 may serve as an actuation portion of the rotation mechanism 1012, and is configured to be operatively coupled to the actuated portion 116. The extension direction of each of the four sliding grooves 1051, 1052, 1053, 1054 is disposed at a specified angle to, for example, perpendicular to, the extension direction of the corresponding one of the four inertial piece acting portions 1031, 1032, 1033, 1034. Each of the four inertial balls 1041, 1042,1043, 1044 is of relatively high density and mass, and is accommodated in the corresponding one of the four sliding grooves 1051, 1052, 1053, 1054, and can roll in the sliding groove. Each of the four inertial balls 1041, 1042, 1043, 1044 includes an initial rolling position and a rolling end position. Each of the four inertial piece acting portions 1031, 1032, 1033, 1034 includes an initial rotation position and a rotation end position. Each of the four inertial balls 1041, 1042, 1043, 1044 abuts, at the initial rotation position, the corresponding one of the four inertial piece acting portions 1031, 1032, 1033, 1034. Any of the four inertial balls 1041, 1042, 1043, 1044 can roll in the corresponding one of the four sliding grooves 1051, 1052, 1053, 1054 when subjected to a corresponding actuation force, thereby driving the corresponding one of the four inertial piece acting portions 1031, 1032, 1033, 1034 to rotate in the first rotation direction, thereby causing the rotation mechanism 1012 to rotate in the first rotation direction.

As shown in FIG. 10A to FIG. 10C, the structures of the four sliding grooves 1051, 1052, 1053, 1054 are the same. The structure of the sliding groove 1051 is described here as an example. The sliding groove 1051 includes a sliding groove stop wall 1061 which is located at an initial end of the sliding groove 1051 and is configured to prevent the inertial ball 1041 from rolling backward. In the initial rotation position of the inertial piece acting portion 1031, the inertial ball 1041 is in an initial rolling position in the sliding groove 1051, and is restrained between the stop wall 1061 and the inertial piece acting portion 1031. When the vehicle is subjected to a collision force (for example, the collision force F4 in FIG. 7C) from a left side direction (referring to the upper right side direction in FIG. 10C), the inertial ball 1041 produces leftward motion inertia. Driven by the motion inertia, the inertial ball 1041 rolls to push the inertial piece acting portion 1031 to rotate in the first rotation direction, thereby driving the rotation mechanism 1022 to rotate in the first rotation direction, and consequently causing the actuated portion 116 to rotate to ultimately extend out the handle. As blocked by the stop wall 1063 of the sliding groove 1053, the inertial ball 1043 is unable to roll. As blocked by the sidewalls of the sliding groove 1052 and the sliding groove 1054, respectively, the inertial ball 1042 and the inertial ball 1044 are unable to roll. The other three inertial balls 1042, 1043, 1044 operate on the same principle as the inertial ball 1041, which will not be described in detail here.

Those skilled in the art should understand that in other embodiments, the inertial piece may also be an inertial sliding block that can slide in the sliding groove under an inertial force, thereby pushing the inertial piece acting portion to rotate.

In a fourth embodiment of the present disclosure, the inertial motion of the inertial piece pushes the inertial piece acting portion is rotate. The structure is simpler, and makes the production more cost-effective.

As can be seen, in the above four embodiments of the present disclosure, under an acceleration of any horizontal direction exceeds a threshold, at least one of the four inertial piece acting portions of the rotation mechanism generates rotational inertia to cause the rotation mechanism to rotate in the first rotation direction, thereby driving the handle to move.

As will be appreciated by those skilled in the art, the handle assembly in the present disclosure is configured not only to drive a rotary hidden handle to extend out, but also to drive a sliding-type hidden handle (for example, one with a four-bar linkage) to extend out.

As will be appreciated by those skilled in the art, when the handle is in the extended position, a pressing force may be applied to the handle from the outside of the handle to push the handle toward the retracted position, so that the actuated portion can inversely drive the inertial piece acting portion of the rotation mechanism to rotate from the rotation end position back to the initial rotation position against the blocking force of the elastic limiting structure.

Due to an inertial piece serving as a driving component and a rotation mechanism disposed in the handle assembly of the present disclosure, when the vehicle collides, the inertial piece drives the rotation mechanism to rotate. This drives the handle to extend out, allowing the operator to open the door through the extended handle. Therefore, the handle assembly of the present disclosure enables automatic extending of the handle by transferring the inertial energy generated by the collision of the inertial piece to the handle, without a need to extend out the handle by using a conventional driving apparatus such as a motor.

Furthermore, by means of structural design of the rotation mechanism, the handle assembly of the present disclosure can generate an inertial driving force as long as the acceleration at any horizontal direction (including but not limited to, front, rear, left, and right side directions) generated by a collision exceeds a threshold, thereby enabling the handle to be extended out more smoothly in response to a collision condition.

In addition, by means of coaxial arrangement of the rotation mechanisms, the handle assembly of the present disclosure enables position limiting and energy release under various collision conditions by simply providing one return device.

In addition, the handle assembly of the present disclosure facilitates flexible utilization of the space of the handle assembly by arranging the two rotation mechanisms separately.

In addition, the handle assembly of the present disclosure can be restored to the original position by pressing after being extended out in a case of a collision, and therefore, can be reused even after undergoing collision conditions.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### List of reference signs:

Handle Assembly 100/800/900/1000

Handle Seat 102/1002

Upper Seat Surface 103

Handle 104

Rotation Mechanism 112/1012

At Least One Inertial Piece 113

Handle Pivot 114/914

Actuated Portion 116/916

Baffle 118

Clearance Groove 132, 134

Elastic Limiting Structure 142, 144

Stepped Structure 151

Stop Structure 152

Pivot 212

Pivot Connecting Portion 219

First Rotation Mechanism 222/822/922

Second Rotation Mechanism 224/824/924

Return Device 226

Counterweight 241, 242, 243, 244

First Inertial Piece Acting Portion 302, 304

Actuation Portion 306

First Rotation Body 308

Receiving Groove 312, 314

First Pivot Cavity 316

Second Inertial Piece Acting Portion 402, 404

Second Rotation Body 408

Receiving Groove 412, 414

Second Pivot Cavity 416

Pivot Opening 502

First Extension Section 504

Extension Protruding Section 506

Second Extension Section 508

First Blocking Ramp 512

Second Blocking Ramp 514

Two Baffles 917, 918

Two Stop Structures 932, 934

Upper Cover 1014

Four Inertial Piece Acting Portions 1031, 1032, 1033, 1034

Four Inertial Balls 1041, 1042, 1043, 1044

Four Sliding Grooves 1051, 1052, 1053, 1054

Sliding Groove Stop Wall 1061, 1063

What is claimed is:

1. A handle assembly, used for a vehicle, comprising:
a handle seat;
a handle mounted on the handle seat and having a retracted position and an extended position;
a rotation mechanism rotatably mounted on the handle seat and operatively coupled to the handle; and
at least one inertial piece which is disposed on the rotation mechanism, or at least partially forms the rotation mechanism, or is capable of acting on the rotation mechanism;
wherein the at least one inertial piece is configured to move relative to the handle seat when an acceleration of the vehicle exceeds a threshold, and drive the rotation mechanism to rotate in a first rotation direction to drive the handle to move from the retracted position to the extended position.

2. The handle assembly of claim 1, further comprising:
a stop structure, wherein the stop structure is disposed on the handle seat, and is in fit with the rotation mechanism to prevent the rotation mechanism from rotating in a second rotation direction opposite to the first rotation direction when the rotation mechanism is in an initial rotation position thereof.

3. The handle assembly of claim 2, further comprising:
an elastic limiting structure disposed on the handle seat;
wherein the elastic limiting structure is configured to provide the rotation mechanism with a first blocking force that prevents rotation in the first rotation direction when the rotation mechanism is in the initial rotation position, and provide the rotation mechanism with a second blocking force that prevents rotation in the second rotation direction when the rotation mechanism is in a rotation end position thereof.

4. The handle assembly of claim 3, wherein
the elastic limiting structure comprises an elastic cantilever connected to the handle seat, the elastic cantilever is provided with a first blocking ramp and a second blocking ramp, wherein the elastic limiting structure provides the first blocking force through the first blocking ramp and provides the second blocking force through the second blocking ramp.

5. The handle assembly of claim 1, wherein the rotation mechanism further comprises a rotational main body and at least one inertial piece acting portion connected to the rotational main body;
wherein the at least one inertial piece is disposed on the at least one inertial piece acting portion, or at least partially forms the at least one inertial piece acting portion, or is capable of acting on the at least one inertial piece acting portion.

6. The handle assembly of claim 5, wherein
the rotation mechanism is operatively coupled to the handle through the at least one inertial piece acting portion; or
the handle assembly further comprises an actuation portion connected to the rotational main body, and the rotation mechanism is operatively coupled to the handle through the actuation portion.

7. The handle assembly of claim 1, further comprising:
a handle pivot, the handle being fixedly connected to the handle pivot in a rotation direction and being rotatably connected to the handle seat through the handle pivot; and
an actuated portion disposed on the handle pivot or the handle;
wherein, the rotation mechanism is capable of acting on the actuated portion to operatively couple the rotation mechanism to the handle, to drive, through the rotation mechanism, the handle to rotate.

8. The handle assembly of claim 1, further comprising:
a handle transmission piece and a handle pivot, the handle transmission piece being fixedly connected to the handle pivot in a rotation direction and being rotatably connected to the handle seat through the handle pivot, and the handle being connected to the handle transmission piece; and
an actuated portion disposed on the handle pivot or the handle transmission piece;
wherein, the rotation mechanism is capable of acting on the actuated portion to operatively couple the rotation mechanism to the handle, to drive, through the rotation mechanism, the handle transmission piece to rotate, and consequently drive the handle to move.

9. The handle assembly of claim 5, wherein
the at least one inertial piece acting portion comprises four inertial piece acting portions disposed around the rotational main body; and
the at least one inertial piece comprises four inertial pieces.

10. The handle assembly of claim 9, wherein
each of the inertial piece acting portions is arm-shaped, and extends in a radial direction of the rotational main body, wherein extension directions of two adjacent inertial piece acting portions are perpendicular to each other.

11. The handle assembly of claim 9, wherein
the four inertial pieces are disposed on the four inertial piece acting portions, respectively, or at least partially form the four inertial piece acting portions, respectively;
wherein the rotation mechanism comprises a first rotation mechanism and a second rotation mechanism, and the first rotation mechanism and the second rotation mechanism are rotatable independently of each other;
wherein two of the four inertial piece acting portions are disposed on the first rotation mechanism, and the other two of the four inertial piece acting portions are disposed on the second rotation mechanism; and
wherein the first rotation mechanism and the second rotation mechanism are arranged in a coaxial manner or in a distributed manner.

12. The handle assembly of claim 5, further comprising:
at least one sliding groove disposed on the handle seat;
wherein the at least one inertial piece is movably accommodated in the at least one sliding groove, and is capable of acting on the at least one inertial piece acting portion during movement thereof, to enable the rotation mechanism to rotate in the first rotation direction.

13. The handle assembly of claim 12, wherein the at least one inertial piece is at least one inertial ball.

14. The handle assembly of claim 1, further comprising:
a return device, wherein the return device is disposed between the handle seat and the rotation mechanism, and provides the rotation mechanism with a return force that causes rotating in a second rotation direction opposite to the first rotation direction.

15. A vehicle, comprising: a handle assembly of any one of claim 1.
